(19) United States
(12) Patent Application Publication
(10) Pub. No.: US 2014/0057360 A1
(43) Pub. Date: Feb. 27, 2014

(54) ARRANGEMENT AND METHOD FOR DETECTING HYDROGEN PEROXIDE

(71) Applicants: Petra Neff, Stuttgart (DE); Markus Widenmeyer, Schoenaich (DE)

(72) Inventors: Petra Neff, Stuttgart (DE); Markus Widenmeyer, Schoenaich (DE)

(73) Assignee: Robert Bosch GmbH, Stuttgart (DE)

(21) Appl. No.: 13/983,142

(22) PCT Filed: Dec. 14, 2011
(86) PCT No.: PCT/EP2011/072795

§ 371 Date: Nov. 13, 2013

(30) Foreign Application Priority Data
Feb. 7, 2011 (EP) 10 2011 003 720.9

(51) Int. Cl. G01N 31/22

(52) U.S. Cl. CPC G01N 31/223
USPC 436/135; 422/86

(57) ABSTRACT

An arrangement for detecting hydrogen peroxide includes a sample space configured to receive a hydrogen-peroxide-containing gas. The sample space is fluidically connected to a hydrogen-peroxide-selective colorimetric detection reagent. The arrangement also includes at least one radiation source configured to irradiate the detection reagent and at least one detector configured to detect at least one optical property of the colorimetric detection reagent. This arrangement enables detection of hydrogen peroxide in the gaseous phase without the need to transfer hydrogen peroxide to the liquid phase. As a result, a simplified measurement behavior and additionally a highly sensitive measurement are attained.

The present invention relates to an arrangement and a method for detecting hydrogen peroxide, in particular in a hydrogen peroxide-containing gas.

### STATE OF THE ART

Hydrogen peroxide is widely distributed in many use fields. For example it is used as an oxidizing agent, bleaching agent or for disinfecting and sterilizing in industrial applications or also in the field of medicine. In addition, hydrogen peroxide finds use in agriculture or other biological applications, such as for oxygen enrichment.

Various sensors and methods are known for detecting hydrogen peroxide. In particular, optical sensors which are based on the change in optical properties of a substance through the influence of hydrogen peroxide are used.

Thus for example the embedding of europium-tetracycline complexes into a polyacrylonitrile copolyacrylamide polymer matrix and observation of the fluorescence behavior in a hydrogen peroxide-containing solution in order to detect hydrogen peroxide is known from Otto S. Wolfbeis, Reversible Optical Sensor Membrane for Hydrogen Peroxide Using an Immobilized Fluorescent Probe, and its Application to a Glucose Biosensor, Microchim. Acta 143, 221-227 (2003). A further approach which is known from Aleksandra Lobnik, Sol-gel based optical sensor for continuous determination of dissolved hydrogen peroxide, Sensors and Actuators B 74 (2001), 194-199, consists in the use of the indicator Meldola blue. This is incorporated in sol-gel layers and brought into contact with an aqueous hydrogen peroxide-containing solution. Through the influence of the hydrogen peroxide, the optical properties of the indicator change, and this can be evaluated spectrophotometrically.

A further known test for hydrogen peroxide is based on a reaction of hydrogen peroxide with titanium (Ti(IV)) complexes. For example, it is known from Yuichi Komazaki, Automated measurement system for H₂O₂ in the atmosphere by diffusion scrubber sampling and HPLC analysis of Ti(IV)-PAR-H₂O₂ complex, Analyst, 2001, 126, 587-593 that hydrogen peroxide present in the atmosphere can be washed into a liquid solution and is spectrophotometrically detectable there by means of a Ti(IV)-PAR complex.

### DISCLOSURE OF THE INVENTION

The subject of the present invention is an arrangement for detecting hydrogen peroxide, comprising a sample space for receiving a hydrogen peroxide-containing gas, wherein the sample space is fluidically connected to a hydrogen peroxide-selective colorimetric detection reagent, further comprising at least one radiation source for irradiation of the detection reagent, and at least one detector for detecting at least one optical property of the colorimetric detection reagent.

In the context of the invention, a hydrogen peroxide-selective colorimetric detection reagent is understood to mean in particular a substance which is suitable for detecting hydrogen peroxide on the basis of optical properties. Also, it may exclusively detect hydrogen peroxide, that is be exclusively selective for this substance, or else as well as hydrogen peroxide also detect other substances, that is also be selective for these. However, in order not to interfere with the qualitative and quantitative detection of hydrogen peroxide it is advantageous that the detection reagent be selective for no other substances contained in the hydrogen peroxide-containing gas. In this case, according to the invention the detection reagent also serves for a colorimetric detection, that is a detection based on a change in at least one optical property. At least one optical property is understood to mean in particular the absorption behavior or the emission behavior of the colorimetric detection reagent. This means for example that the detection reagent absorbs radiation of a certain wavelength, wherein the wavelength is in particular dependent on the formation of a complex with hydrogen peroxide. The different absorption behavior can then for example be measured by the detector via an absorption spectrum. However, other possibilities with which the specific and hydrogen peroxide-dependent absorption behavior can be measured, for example investigation of the transmission or fluorescence behavior are also feasible according to the invention.

Further, in the context of the invention a detection reagent fluidically connected to the sample space means in particular that the detection reagent is located in the sample space itself or in a separate space which is fluidically connected to the sample space. In this case, the detection reagent can for example be arranged centrally in the particular space or on a wall of the space. Further, it is advantageous if the detection reagent is arranged such that the hydrogen peroxide-containing gas flows along this.

According to the present invention, an optical sensor for hydrogen peroxide is created, with which hydrogen peroxide is directly measured in the gas phase. Hence according to the invention it is not necessary to transfer the hydrogen peroxide to be detected from the gas phase into a liquid phase for example by condensation processes, gas scrubbing processes or other processes, and to assay the liquid phase, for example an aqueous solution. Rather, the gas phase can be used directly as the measurement medium and be transferred into the arrangement or into the sample space. As a result, a detection of hydrogen peroxide with the arrangement according to the invention can be effected very inexpensively.

Further, in this case the arrangement according to the invention is producible very inexpensively, since in principle consists merely of a radiation source, a sample space with detection reagent and a detector. As a result, both the production and also the operation and the maintenance of the arrangement according to the invention is not associated with disproportionately high costs.

Further, the arrangement according to the invention can be very compactly designed, which makes it particularly simply possible for example to design the arrangement as a portable sensor. As a result for example the ambient air can be tested on site, which allows great flexibility of the application fields possible with the arrangement according to the invention. Hence in situ measurements are also possible, wherein for example reaction gas or the like can be passed directly into the sample space, so that for example real-time monitoring of a plurality of possible processes is possible.

Also, with the arrangement according to the invention it is possible through increased sensitivity to be able to qualitatively and quantitatively detect even the smallest quantities of hydrogen peroxide. In particular, with the arrangement according to the invention it is possible to be able to detect and quantify traces of hydrogen peroxide in a range of ≧0.1 ppb, for example up to a range of ≦1000 ppb.

In the context of an advantageous embodiment of the present invention, the at least one radiation source is designed as a UV/visible radiation source. The means in particular that the radiation source is designed to emit radiation with a wavelength in the range from ≧200 nm to ≦800 nm. Here the exact wavelength or the exact wavelength range is in particular selected depending on the optical properties of the colorimetric detection reagent or its absorption properties. Radiation sources in the UV/visible range are widely distributed and are thus available readily and without disproportionately high cost-intensive expenditure. Hence in this configuration measurements by IR spectroscopy, which are often markedly more expensive to perform, can be dispensed with, which renders use of the arrangement according to the invention particularly simple. Also, UV/visible radiation are especially suitable for use in studying the optical properties, such as the absorption behavior, of a broad range of detection reagents.

In the context of a further advantageous embodiment of the present invention, the at least one radiation source is designed as a light-emitting diode. By means of light-emitting diodes, radiation of a precisely defined wavelength can be generated, which thus enables a very precise measurement of the hydrogen peroxide. In addition, light-emitting diodes are inexpensive to produce and operate, which also makes the operation of the arrangement according to the invention more economical. In addition, light-emitting diodes can be operated with low power consumption, which also makes the power consumption of the whole arrangement low. As a result, this embodiment of the arrangement according to the invention is particularly suitable for portable applications since unsuitable high energy reserves such as for example a plurality of mostly heavy and thus unwieldy storage batteries can be dispensed with.

In the context of a further advantageous embodiment of the present invention, the at least one detector is designed as a photodiode. By means of a photodiode, the detected radiation can in a simple manner be converted into electric current or into electrical potential and in this manner be evaluated. Photodiodes also offer excellent precision, in order to be able to detect and quantify even the smallest concentrations of hydrogen peroxide in the hydrogen peroxide-containing gas.

In the context of a further advantageous embodiment of the present invention, the detection reagent comprises an organometallic or inorganic complex compound, such as for example a titanium(IV) complex. Such complexes are particularly well suited as colorimetric detection reagents, since with them the smallest concentrations of hydrogen peroxide are already detectable. In principle, colored peroxide complexes, which for their part are readily detectable, can be formed from such complexes through the action of hydrogen peroxide.

In the context of a further advantageous embodiment of the present invention, the detection reagent is located in a porous organic or inorganic matrix. As a result, a precisely defined contact area of the reagent with the hydrogen peroxide-containing gas which makes precisely defined and reproducible measurements possible can be achieved. Further, a porous matrix is well suited for having a gas flow through it, or for allowing a gas to diffuse into the matrix, which in turn makes very suitable measurement conditions possible and moreover facilitates the arrangement of the reagent for example in the sample space. In this manner, great flexibility as regards the embodiment of the arrangement according to the invention is enabled. In addition, in this manner the detection reagent, when it is consumed and has to be renewed, can easily be replaced, for example by renewing the matrix.

In this case, the matrix is preferably formed of one or more oxides of a metal such as for example aluminum, or a semi-metal such as for example silicon or boron. Further, a silicate matrix or metallosilicate matrix can be used, which is in particular selected from the group of the zeolite-containing materials. Further, an organic polymer matrix, such as for example a matrix of ethylcellulose or a polystyrene resin, can be used according to the invention. This makes it possible for the fluid to be measured to enter optimally into contact with the detection reagent. In this case, those matrix-forming materials interact only insignificantly with the hydrogen peroxide. The detection of hydrogen peroxide is thus not disturbed by such materials. Further, it is preferable that the matrix be porous. In this case it is particularly preferable that the matrix be a mesoporous matrix. A mesoporous matrix is characterized by its pore diameter, which lies in a range from ≧2 nm to ≦50 nm. With such pores, a particularly advantageous contact between the hydrogen peroxide-containing gas and the detection reagent can be achieved. Alternatively, the matrix can be microporous, wherein the pore diameter lies in a range of ≦2 nm. This means in particular that the pores present in the agent are mesoporous or microporous, since there can always be deviations from the micro- or meso-porosity.

In the context of a further advantageous embodiment of the present invention, an optical conductor is provided which is arranged such that radiation emitted from the radiation source is passed into the optical conductor, and which surrounds the colorimetric detection reagent such that it can be irradiated by the emitted radiation. For example, an optical conductor can be used which can be made of glass or a plastic. For example, the optical conductor can in this case be coated with the colorimetric detection reagent. The light thus passed or the radiation thus passed then interacts with the detection reagent, wherein the optical properties are detectable by the detector.

In the context of a further advantageous embodiment of the present invention, the sample space has a gas inlet and a gas outlet, wherein valves are provided in the gas inlet and in the gas outlet. As a result, a precisely defined gas volume can be introduced into the sample space, which can then also be assayed over a longer period. In this embodiment, it can especially simply be ensured that, even with a potentially long response time of a detection reagent, precise measurement results are achievable even at very low concentrations.

A further subject of the present invention is a method for detecting hydrogen peroxide, comprising the steps: introduction of a hydrogen peroxide-containing gas into a sample space in order to bring the hydrogen peroxide-containing gas into contact with a hydrogen peroxide-selective colorimetric detection reagent; irradiation of the detection reagent with radiation of defined wavelength; and detection of at least one optical property of the colorimetric reagent.

With the method according to the invention, the advantages described with reference to the arrangement according to the invention can be achieved. In particular, with the method according to the invention it is possible to detect hydrogen peroxide directly in the gas phase qualitatively and quantitatively. Thus an analytical method which is simple to implement, wherein no disproportionately high costs are incurred and at the same time the hydrogen peroxide to be detected is detectable at a precision down to 0.1 ppb becomes possible.

In the context of an advantageous embodiment of the method according to the invention, the detection reagent is irradiated with a wavelength in a range from ≧200 nm to ≦800 nm. Hence radiation in the UV/visible region is used. The exact wavelength used here is in particular dependent on the nature of the colorimetric detection reagent used. Such radiation is particularly suitable for investigating the optical properties, or the absorption or emission behavior, of a plurality of hydrogen peroxide-selective detection reagents and at the same time is simple and inexpensive to produce.

Further advantages and advantageous embodiments of the subjects according to the invention are illustrated by the drawing and explained in the description below. Here it should be noted that the drawing is only of a descriptive character and is not intended to limit the invention in any form.

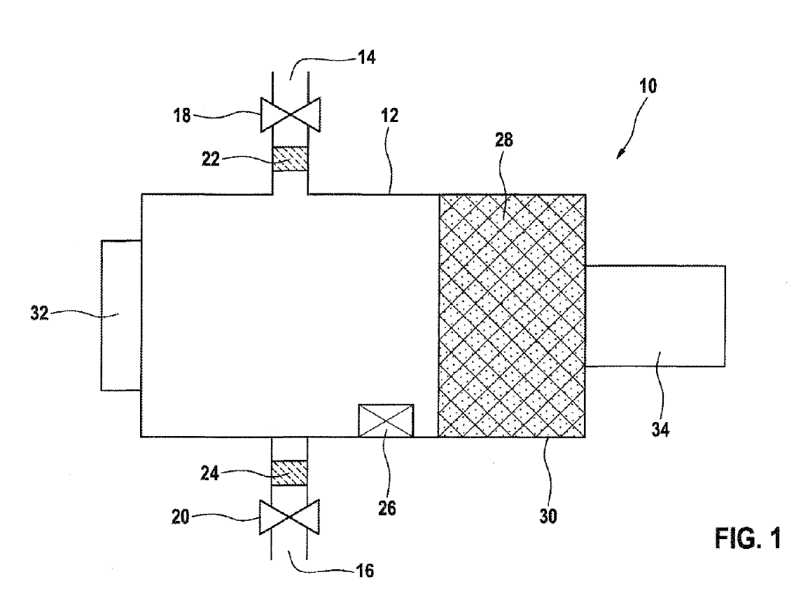

FIG. 1 shows a diagrammatic cross-section of an arrangement according to the invention.

In FIG. 1, an arrangement 10 according to the invention for detecting hydrogen peroxide is shown diagrammatically. Through such an arrangement 10 according to the invention, it is made possible directly to determine hydrogen peroxide in the gas phase of a hydrogen peroxide-containing gas to qualitatively and quantitatively. The arrangement 10 can for example be designed as a fixed sensor and for example be used as laboratory equipment. In addition, the arrangement 10 can be used as a portable sensor, in particular for the analysis of the atmosphere, room air or for in situ applications.

The arrangement 10 according to FIG. 1 comprises a sample space 12 for receiving a hydrogen peroxide-containing gas the hydrogen peroxide content whereof is to be qualitatively and/or quantitatively investigated. For this, the sample space 12 preferably has a gas inlet 14 and a gas outlet 16. In this manner, the hydrogen peroxide-containing gas can be passed through the sample space 12. In order for example to obtain that the hydrogen peroxide-containing gas to be tested remains within the sample space 12 for a longer measurement cycle, valves 18 and 20 can be provided in the gas inlet 14 and in the gas outlet 16 in order to effect gas-tight closure of the gas inlet 14 and the gas outlet 16.

Further, a flowmeter 22 and 24 can be provided in the gas inlet 14 and/or in the gas outlet 16, in order to determine respectively what volume of gas flows into the sample space 12 and out again. By taking account of the exact volume thus determinable, a quantitative measurement can be very precisely configured. Alternatively or in addition, a pressure measurement device 26 can be located in the sample space 12 in order to determined the pressure of the hydrogen peroxide-containing gas present in the sample space 12 and thus also to infer the quantity of gas present in the sample space 12.

The sample space 12 is fluidically connected to a hydrogen peroxide-selective colorimetric detection reagent 28. This means that the detection reagent 28 is located in the sample space 12 itself, or in a space fluidically connected to the sample space 12. According to FIG. 1, the detection reagent 28 is arranged in the sample space 12 itself. The detection reagent 28 can be immobilized in the sample space 12 in any desired and suitable manner, so that the hydrogen peroxide-containing gas can come into contact with the detection reagent 28, as a result of which the hydrogen peroxide interacts or reacts with the detection reagent 28.

According to FIG. 1, the detection reagent 28 is located in a matrix 30. The matrix 30 is preferably mesoporous, wherein the detection reagent 28 can be located in the appropriate pores. In the case of a mesoporous matrix 30, this has pores with a diameter in a range from ≧2 nm to ≦50 nm. As a result, a suitable quantity of hydrogen peroxide-containing gas can flow or diffuse into the matrix 30 and thus react with the detection reagent 28. Particularly preferably, the detection reagent 28 is located in a porous organic or inorganic matrix 30. As advantageous examples, a meso-porous matrix for med of one or more oxides of a metal, such as for example aluminum, or a semi-metal, such as for example silicon or boron may be mentioned. Further, a microporous silicate matrix or metallosilicate matrix can be used, which is in particular selected from the group of the zeolite-containing materials. Furthermore, an organic polymer matrix, such as for example a matrix of ethylcellulose or a polystyrene resin, can also be used according to the invention.

Advantageously in this case, the detection reagent 28 is embedded in the matrix 30 such that its optical and chemical properties essentially remain unchanged and in addition essentially undisturbed diffusion of the hydrogen peroxide-containing gas into the matrix 30 is possible.

The hydrogen peroxide-selective colorimetric detection reagent 28 serves to enable the qualitative and quantitative detection of hydrogen peroxide. Particularly suitable here according to the invention are organo-metallic or inorganic complex compounds which can for example form colored peroxide complexes through the action of hydrogen peroxide. Particularly preferable here are complexes of the fourth, fifth and sixth main group of the periodic system of the elements, wherein titanium(IV) complexes can particularly preferably be used. Examples of titanium(IV) complexes which can be used in a particularly suitable manner according to the invention are for example titanium(IV)-porphyrin complexes or derivatives thereof.

In order to be able to investigate at least one optical property of the detection reagent 28 changed by interaction or reaction of the detection reagent 28 with the hydrogen peroxide, such as for example the absorption properties or emission properties, the arrangement 10 according to the invention further comprises at least one radiation source 32 for irradiating the detection reagent 28. The at least one radiation source 32 is preferably designed as a UV/visible radiation source. This means that the radiation source 32 emits light with a wavelength in a range from ≧200 nm to ≦800 nm and irradiates at least a part of the sample space 12 or the detection reagent 24 with this wavelength. In this case, it is particularly preferable that the radiation source 32 be designed as a light-emitting diode.

Furthermore, the arrangement 10 comprises at least one detector 34 for detecting at least one optical property of the colorimetric detection reagent. For example, the absorption behavior or the emission behavior of the detection reagent 28 can be investigated by means of the detector 34 before and in particular after the reaction with the hydrogen peroxide and thereby the change in this behavior can be qualitatively and quantitatively determined, which enables a qualitative and quantitative investigation of the hydrogen peroxide content in the hydrogen peroxide-containing gas.

The detector 34 is therefore advisably an optical detector. Particularly preferably, the detection 34 is designed as a photodiode. However, other types of detectors are also possible according to the invention. For example, a photoresistor and a phototransistor may be mentioned here.

The radiation source 32 here can be capable of activation or inactivation by an electrical control system, wherein the control system is preferably also connected to the detector 34 and/or the valves 18 and 20.

A method according to the invention for the detection of hydrogen peroxide performed with the arrangement according to the invention proceeds as follows. Firstly, a hydrogen peroxide-containing gas the hydrogen peroxide content whereof is to be measured is passed into the sample space 12 of the arrangement 10. For this, for example it passes through the gas inlet 14. Here, both a continuous introduction of the gas in the sample space 12 is possible, and also an intermittent introduction, wherein the gas can remain in the sample space 12 for a defined period for the measurement. In the sample space 12, or in a space fluidically connected to the sample space 12, the hydrogen peroxide-containing gas is thereby brought into contact with the hydrogen peroxide-selective colorimetric detection reagent 28. For example, the gas passes into the pores of the matrix 30, in order there to react with the colorimetric detection reagent 28.

During this, a change in the optical properties such as for example the spectral absorption properties or emission properties of the detection reagent 28 takes place because of the hydrogen peroxide, which can be detected by means of the radiation source 32 and the detector 34 and thus enable a determination of the hydrogen peroxide in the gas phase.

For this, the sample space 12 or the detection reagent 28 is therefore irradiated with defined radiation by the radiation source 32. For this, radiation of a wavelength in a range from ≧200 nm to ≦800 nm, depending on the detection reagent, is preferably used.

After the measurement, the gas is passed out of the sample space 12, and for this for example passes through the gas outlet 16. The detection reagent 28 can mostly be used for a plurality of measurement cycles or for a defined measurement period, before it might under some circumstances have to be regenerated.

In this regard, a distinction can essentially be made between two cases. If both the formation and also the decomposition of the compound formed from the detection reagent 28 through exposure to hydrogen peroxide, such as for example a hydrogen peroxide complex, is little inhibited kinetically, the thermodynamic equilibrium is established within a short time. In this case, no regeneration step is necessary after exposure to the hydrogen peroxide-containing gas. Rather, in the absence of hydrogen peroxide the decomposition of the compound of hydrogen peroxide and the detection reagent 28 formed occurs, so that the detection reagent 28 is essentially obtained again. If on the other hand the decomposition of the compound formed is very slow compared to its formation, then after the exposure to the hydrogen peroxide-containing gas and the measurement, or a certain number of measurements, a regeneration step must be performed in order to make the arrangement 10 ready for use again. For this, for example the temperature can be temporarily increased with the aim of obtaining a decomposition of the compound formed or residual hydrogen peroxide. If apart from this the detection reagent 28 is not sufficiently stable over a prolonged period, in both aforesaid cases a replacement of the detection reagent 28 can be effected, for example by replacing part of the sensor system or by fresh charging with detection reagent 28.

1. An arrangement for detecting hydrogen peroxide, comprising:
a sample space configured to receive a hydrogen peroxide-containing gas, the sample space fluidically connected to a hydrogen peroxide-selective colorimetric detection reagent;
at least one radiation source configured to irradiate the detection reagent; and
at least one detector configured to detect at least one optical property of the colorimetric detection reagent.

2. The arrangement as claimed in claim 1, wherein the at least one radiation source is a UV/visible radiation source.

3. The arrangement as claimed in claim 1, wherein the at least one radiation source is a light-emitting diode.

4. The arrangement as claimed in claim 1, wherein the at least one detector is a photodiode.

5. The arrangement as claimed in claim 1, wherein the detection reagent includes one of an organometallic and an inorganic complex compound.

6. The arrangement as claimed in claim 1, wherein the detection reagent is arranged in one of a porous organic and an inorganic matrix.

7. The arrangement as claimed in claim 1, further comprising:
a light conductor located such that radiation emitted from the radiation source is conducted in the light conductor, the light conductor surrounding the colorimetric detection reagent such that the colorimetric detection reagent can be irradiated by the emitted radiation.

8. The arrangement as claimed in claim 1, wherein:
the sample space has a gas inlet and a gas outlet, and
each of the gas inlet and the gas outlet includes valves.

9. A method for detecting hydrogen peroxide, comprising:
introducing a hydrogen peroxide-containing gas into a sample space to bring the hydrogen peroxide-containing gas into contact with a hydrogen peroxide-selective detection reagent;
irradiating the detection reagent with radiation of a defined wavelength; and
detecting at least one optical property of the colorimetric detection reagent.

10. The method as claimed in claim 9, wherein the detection reagent is irradiated with a wavelength which is greater than or equal to 200 nm and is less than or equal to 800 nm.
